(19) United States
(12) Patent Application Publication
(10) Pub. No.: US 2015/0185425 A1
(43) Pub. Date: Jul. 2, 2015

(54) WIRELESS CONNECTOR WITH A HOLLOW TELESCOPIC WAVEGUIDE

(71) Applicant: 3M INNOVATIVE PROPERTIES COMPANY, St. Paul, MN (US)

(72) Inventors: Douglas B. Gundel, Cedar Park, TX (US); Zulfiqar A. Khan, Austin, TX (US); Alexander W. Barr, Austin, TX (US)

(73) Assignee: 3M INNOVATIVE PROPERTIES COMPANY, St. Paul, MN (US)

(21) Appl. No.: 14/406,796

(22) PCT Filed: Jul. 2, 2013
(86) PCT No.: PCT/US2013/049004

§ 371 Date: Dec. 10, 2014

Related U.S. Application Data
(60) Provisional application No. 61/669,737, filed on Jul. 10, 2012.

(51) Int. Cl. G02B 6/42; H01P 1/06; H04B 1/40; H01P 3/12; H01P 3/16; G02B 6/43; H01P 5/02

(52) U.S. Cl. CPC G02B 6/42; G02B 6/43; H01P 1/06; H01P 5/02; H01P 3/12; H01P 3/16; H04B 1/40

(57) ABSTRACT

Wireless connectors and communication systems are described including a first communication device configured to emit a modulated signal, a second communication device configured to receive the emitted modulated signal and a waveguide disposed between the first and second communication devices and configured to wirelessly receive the emitted modulated signal from a first end of the waveguide, guide the received signal from the first end to an opposite second end of the waveguide, and wirelessly transmit the guided signal from the second end to the second communication device. In some embodiments, the telescopic waveguide includes a plurality of guiding sections, each guiding section being configured to slide within or over an adjacent guiding section inwardly to reduce a length of the telescopic waveguide and outwardly to increase the length of the telescopic waveguide.

### BACKGROUND

Currently, printed circuit boards (PCBs) within an electronic system are typically connected to one another via wired copper connectors either directly or in conjunction with flexible conducting cables. In some cases, particularly where high data transmission speeds are employed, optical cables are also used. Designing these connectors and cables becomes increasingly challenging as the number and the data rates of the connections are increased. The limited available real estate on printed circuit boards (PCBs) further poses significant challenges to designing optimal connector foot prints on the boards. These challenges lead to increased product development time and cost. Connections are a major source for many system level problems, including signal integrity and electromagnetic interference. Even if a given board-to-board connection can be successfully designed, it cannot be easily extended to other scenarios. Further, it is generally not possible to increase complexity of the same system, e.g. addition or restructuring of a PCB, without significant efforts by the system designer.

### SUMMARY

In some embodiments, a wireless connector includes a first communication device configured to emit a modulated signal, a second communication device configured to receive the emitted modulated signal, and a telescopic waveguide disposed between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device. The telescopic waveguide is centered on an axis and includes a plurality of guiding sections, each guiding section being centered on the axis and configured to slide within or over an adjacent guiding section inwardly to reduce a length of the telescopic waveguide and outwardly to increase the length of the telescopic waveguide.

In some embodiments, the telescopic waveguide may not be centered on an axis and at least one guiding section defines a cavity along a length of the guiding section.

In some embodiments, the telescopic waveguide includes first and second guiding sections, the second guiding section becoming increasingly wide in at least one dimension approaching the first end of the second guiding section.

In some embodiment, the waveguide comprising a first guiding section and a second guiding section, each of the first and second guiding sections being centered on the axis, a first end of the first guiding section comprising a ball portion, a second end of the second guiding section comprising a socket portion. The ball portion of the first guiding section is disposed within the socket portion of the second guiding portion and is free to move within the socket portion in a plurality of directions.

In some embodiments, at least one guiding section in the plurality of guiding section being rigid, at least one guiding section in the plurality of guiding sections being more flexible than another guiding section.

In some embodiments, a wireless communication system includes a plurality of first communication devices disposed on a common first substrate, each first communication device being configured to emit a modulated signal and a plurality of second communication devices disposed on a common second substrate, each second communication device being associated with a different first communication device and configured to receive the modulated signal emitted by the first communication device. The wireless communication system further includes a plurality of waveguides, each waveguide being centered on an axis and disposed between a different first communication device and the second communication device associated with the first communication device and configured to wirelessly receive the modulated signal emitted by the first communication device from a first end of the waveguide, guide the received signal from the first end to an opposite second end of the waveguide, and wirelessly transmit the guided signal from the second end to the second communication device. At least one waveguide in the plurality of waveguides includes a plurality of guiding sections, each guiding section being centered on the axis of the waveguide and configured to slide within or over an adjacent guiding section inwardly to reduce a length of the waveguide and outwardly to increase the length of the waveguide.

In some embodiments, a wireless communication system includes a plurality of first communication devices disposed on a common first substrate, each first communication device being configured to emit a modulated signal and a plurality of waveguides, each waveguide being associated with a different first communication device and configured to wirelessly receive the modulated signal emitted by the associated first communication device from a first end of the waveguide, guide the received signal from the first end to an opposite second end of the waveguide, and wirelessly transmit the guided signal from the second end of the waveguide. At least one waveguide in the plurality of waveguides includes a first slot at the first end of the waveguide, a portion of the first substrate being inserted into the first slot, wherein the waveguides each define a cavity along a length of the waveguide.

In some embodiments, a wireless communication system includes a plurality of first communication devices disposed on a common first substrate, each first communication device being configured to emit a modulated signal, and a plurality of second communication devices disposed on a common second substrate, each second communication device being associated with a different first communication device and configured to receive the modulated signal emitted by the first communication device. The wireless communication system further includes a waveguide centered on an axis and disposed between the plurality of first communication devices and the plurality of second communication devices, the waveguide being configured to wirelessly receive the modulated signal emitted by each first communication device from a first end of the waveguide, guide the received signal from the first end to an opposite second end of the waveguide, and wirelessly transmit the guided signal from the second end to the second communication device associated with the first communication device. The waveguide includes a plurality of guiding sections, each guiding section being centered on the axis and configured to slide within or over an adjacent guiding section inwardly to reduce a length of the waveguide and outwardly to increase the length of the waveguide.

In some embodiments, a wireless connector includes a first communication device configured to emit a modulated signal, a second communication device configured to receive the emitted modulated signal, and a waveguide disposed between the first and second communication devices and configured to wirelessly receive the emitted modulated signal from a first end of the telescopic waveguide, guide the received signal from the first end to an opposite second end of the waveguide, and wirelessly transmit the guided signal from the second end to the second communication device. The waveguide has a non-uniform permittivity along at least a portion of a length of the waveguide.

### BRIEF DESCRIPTION OF THE DRAWINGS

FIGS. 1 and 2 provide an illustration of one embodiment of a telescoping wireless connector in an electronic system, where FIG. 2 illustrates an expanded configuration of a waveguide with an increased length compared to FIG. 1.

FIGS. 3 and 4 provide an illustration of another embodiment of a telescoping wireless connector in an electronic system, where FIG. 4 illustrates an expanded configuration of a waveguide with an increased length compared to FIG. 3.

FIG. 5 illustrates one embodiment of a telescoping wireless connector in an electronic system including an array of telescoping waveguides.

FIG. 6 illustrates another embodiment of a telescoping wireless connector in an electronic system including an array of telescoping waveguides.

FIG. 7 illustrates another embodiment of a wireless connector including a telescoping waveguide, where at least a portion of the waveguide is flexible.

FIG. 8 illustrates another embodiment of a wireless connector including a telescoping waveguide, where the signal is injected or extracted along the side of the waveguide.

FIG. 9 illustrates another embodiment of a wireless connector including an array of telescoping waveguides, where at least a portion of each waveguide is flexible.

FIG. 10 illustrates an embodiment of an array of waveguides that define slots.

FIG. 11 is a cross-sectional view of one embodiment of a slotted waveguide as illustrated in FIG. 10, with a PCB disposed partially within the slotted waveguide.

FIG. 12 is an end view of one embodiment of a single slotted waveguide with a PCB positioned partially within the slotted waveguide.

FIG. 13 is an end view of one embodiment of multiple slotted waveguides with a PCB positioned partially within the slotted waveguides.

FIG. 14 is an end view of one embodiment of multiple slotted waveguides with a PCB positioned partially within the slotted waveguides, where the PCB includes chips on both sides of the PCB.

FIG. 15 is an end view of one embodiment of multiple slotted waveguides with a PCB positioned partially within the slotted waveguides, where the slotted waveguide includes only partial walls between each waveguide.

FIG. 16 is an end view of one embodiment of multiple slotted waveguides with a PCB positioned partially within the slotted waveguides, where the PCB includes two chips within a single waveguide on each side of the PCB.

FIG. 17 illustrates an embodiment of a wireless connector including a ball and socket joint between waveguide sections.

FIG. 18 illustrates another embodiment of a wireless connector including a ball and socket joint between waveguide sections, where a socket portion is a hollow tube.

FIG. 19 illustrates one embodiment of a wireless connector including a waveguide that is wider than an antenna on a transceiver.

FIG. 20 illustrates one embodiment of a wireless connector including a waveguide that is wider than an antenna on a transceiver, where the transceiver is positioned within the waveguide.

FIG. 21 illustrates one embodiment of a wireless connector including a waveguide within which multiple transceivers are located and communicate with each other.

FIG. 22 illustrates one embodiment of a wireless connector including a waveguide within which multiple transceivers are located and communicate with each other, and where PCBs including multiple transceivers are configured for relative motion.

FIG. 23 illustrates one embodiment of a wireless connector including an inner housing and an outer housing that are capable of relative movement.

FIG. 24 is a side view of the inner and outer housings of FIG. 23.

FIG. 25 illustrates one embodiment of a wireless connector including two inner housings and an outer housing that are capable of relative movement.

FIG. 26 is a side view of the inner and outer housings of FIG. 25.

FIG. 27 is a perspective view of one embodiment of a wireless connector including a waveguide that encloses two PCBs and accommodates relative lateral and rotational motion between the two PCBs.

FIG. 28 is a perspective view of one embodiment of a system where multiple wireless connectors are used to allow relative movement of multiple transceivers.

FIG. 29 is a perspective view of one embodiment of a system where a cable's terminated end is positioned within a waveguide.

FIG. 30 is a perspective view of one embodiment of a system where a cable's terminated end is positioned within a waveguide.

FIG. 31 illustrates one embodiment of a wireless connector structure including a waveguide, two transceivers, two waveguide interfaces between the waveguide ends and the transceivers and two sets of electrical connector structures.

FIGS. 32 to 34 illustrate different embodiments cross-sections of a waveguide partially filled with dielectric materials.

FIG. 35 illustrates one embodiment of a wireless connector including a waveguide fused to a transceiver at both waveguide ends.

FIG. 36 illustrates one embodiment of a wireless connector including a waveguide including a dielectric waveguide interface structure at both waveguide ends, where the each interface structure covers a transceiver at least partially.

FIG. 37 illustrates one embodiment of a side view of a waveguide including an interface end.

FIG. 38 illustrates one embodiment of an end view of the waveguide of FIG. 37, including a rectangular interface end and a rectangular waveguide end.

FIG. 39 illustrates one embodiment of an end view of the waveguide of FIG. 37, including a circular interface end and a rectangular waveguide portion end.

FIG. 40 illustrates one embodiment of an end view of the waveguide of FIG. 37, including a circular interface end and a circular waveguide portion end.

FIG. 41 illustrates one embodiment of an end view of the waveguide of FIG. 37, including a rectangular interface end and a circular waveguide portion end.

FIG. 42 illustrates a cross-sectional view of one embodiment of a waveguide including an interface structure that has a larger diameter at an air interface end than at a waveguide end, and having bubbles of air or a low permittivity dielectric material.

FIG. 43 illustrates a cross-sectional view of one embodiment of a waveguide including an interface structure that has a smaller diameter at an air interface end than at a waveguide end.

FIG. 44 illustrates a cross-sectional view of one embodiment of an interface structure that has a smaller diameter at an air interface end than at a waveguide end, and having bubbles of air or a low permittivity dielectric material.

FIG. 45 illustrates multiple dielectric interface structures connected to a single waveguide

FIG. 46 illustrates a cross-sectional view of a first waveguide fitting within a larger second waveguide.

### DESCRIPTION

Short-range communication of wireless chips can now be realized in small packages, such as less than 3 to 4 mm. The small antenna required can be housed on the same chip or in the package. Communication over longer distances requires more complexity and power to navigate obstacles and transmit the needed distance. Also, for longer distances, various networking schemes may also be required to overcome the crosstalk issues that occur when more than one transceiver pair is utilized. There are therefore several advantages to using low power chips over short distances, with the major disadvantages being range, range of motion, and crosstalk. In some embodiments, communication devices such as transceivers described herein are capable of emitting a power of no more than 1 watt or 0.5 watts. In some embodiments, communication devices such as transceivers described herein are capable of emitting a power of no more than 100 milliwatts, 50 milliwatts, 30 milliwatts, 20 milliwatts or 10 milliwatts.

Several structures described herein can be used to allow chips with low power and small size to extend communication from less than 1 inch to lengths greater than 1 meter. These structures can also increase the ability to move the relative location of the two communicating chips while still enabling communication. In some cases this is achieved for point-to-point communication and structures are provided to address crosstalk issues. In other cases a networked set of wireless transceivers is utilized so that crosstalk is not an issue. In many embodiments, wave guiding structures are used to enable extended distance with increased relative motion.

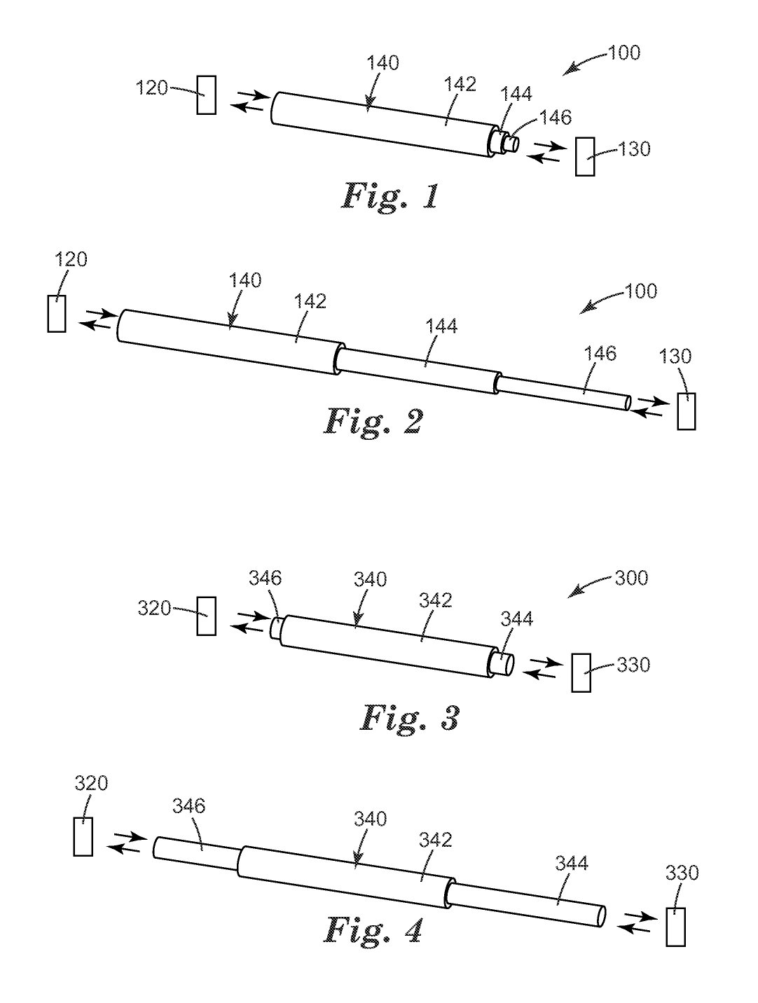

FIGS. 1 and 2 provide an illustration of one embodiment of a telescoping wireless connector in an electronic system, where FIG. 2 illustrates an expanded configuration of a waveguide with an increased length compared to FIG. 1. The wireless connector 100 includes a first communication device 120 configured to emit a modulated signal and a second communication device 130 configured to receive a modulated signal. In one embodiment, both the first and second communication devices 120, 130 are transceivers that are configured to both emit and receive a modulated signal.

The wireless connector 100 further includes a telescoping waveguide 140 that is configured to expand to an increase length or contract to a decreased length. The waveguide 140 is positioned between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device.

As used herein a wireless connection requires a configuration that allows two communication devices to exchange electric signals over a medium which does not allow direct current electric signals to propagate from one communication device to the other communication device. As used herein, a wired connection requires an uninterrupted path of conductive material between two communication devices, where the path is in physical contact with the two communication devices.

The waveguide 140 includes at least two guiding sections. Each guiding section is configured to slide within or over an adjacent guiding section inwardly to reduce a length of the telescopic waveguide and outwardly to increase the length of the telescopic waveguide. At least one guiding section defines a cavity along a length of the guiding section to receive an adjacent guiding section. In some embodiments, the telescopic waveguide 140 is centered on an axis and each guiding section is also centered on the axis.

In the embodiment of FIGS. 1 and 2, the waveguide 140 includes three guiding sections: a first guiding section 142, a second guiding section 144 and a third guiding section 146. The second guiding section 144 is configured to slide within the first guiding section 142 and the third guiding section 146 is configured to slide within the second guiding section 144.

For waveguide 140 of FIGS. 1 and 2, and for other waveguides described here in that include guiding sections, there are many options for configuration and materials. All of the guiding sections except the smallest guiding section define a hollow cavity along the length of the guiding section, so that they can receive smaller guiding sections in a sliding relationship. The smallest guiding section can be either a solid structure or can define a hollow cavity along its length.

In some embodiments, the waveguide and the guiding sections are tubular. The term tubular is used herein to mean a structure that is longer than it is wide, has a uniform cross-section, and defines a cavity along its length. A tubular waveguide is not limited to a cylindrical waveguide, and may have a cross-section that is square, rectangular, round or any other shape.

The waveguide can be square, rectangular, round, or any other shape. The material of guiding portions of the waveguide that define a hollow cavity can be metal, metal-coated ceramic, metal-coated polymer, ceramic or polymer. If the smallest guiding portions are rods instead of defining a hollow cavity, the guiding portions may be solid polymer rods. Options for polymer materials include polyolefin and fluorinated polymers (such as Polytetrafluoroethylene, PTFE, or PVDF) (acetal, polyamide, polycarbonate, polysulfone and others, or polymers with significant inclusion of a low attenuation dielectric such as air. Examples include foamed polyethylene or polypropylene. Where polymer is used in the guiding sections, the polymer can be loaded with materials that improve wave guiding performance such as high dielectric constant materials, such as having a dielectric constant greater than air, that can allow the structure to have a smaller cross section. In some embodiments, the dielectric constant of the guiding material is greater than one.

If polymer, the polymer can be loaded with materials that improve wave guiding performance such as high dielectric constant materials, such as having a dielectric constant greater than air, that can allow the structure to have a smaller cross section.

FIGS. 3 and 4 provide an illustration of another embodiment of a telescoping wireless connector 300 in an electronic system, where FIG. 4 illustrates an expanded configuration of a waveguide with an increased length compared to FIG. 3.

Similar to the embodiment of FIGS. 1 and 2, the wireless connector 300 includes a first communication device 320 configured to emit a modulated signal and a second communication device 330 configured to receive a modulated signal. In one embodiment, both the first and second communication devices 320, 330 are transceivers that are configured to both emit and receive a modulated signal.

The wireless connector 300 further includes a telescoping waveguide 340 that is configured to expand to an increase length or contract to a decreased length. The waveguide 340 is positioned between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device.

The waveguide 340 includes three guiding sections: a central first guiding section 342, a second guiding section 344 that fits within the first guiding section 342 and extends in a first direction, and a third guiding section 346 that also fits within the first guiding section 342 and extends in a second opposite direction. The second and third guiding sections 344, 346 have a smaller diameter than the first guiding section 342.

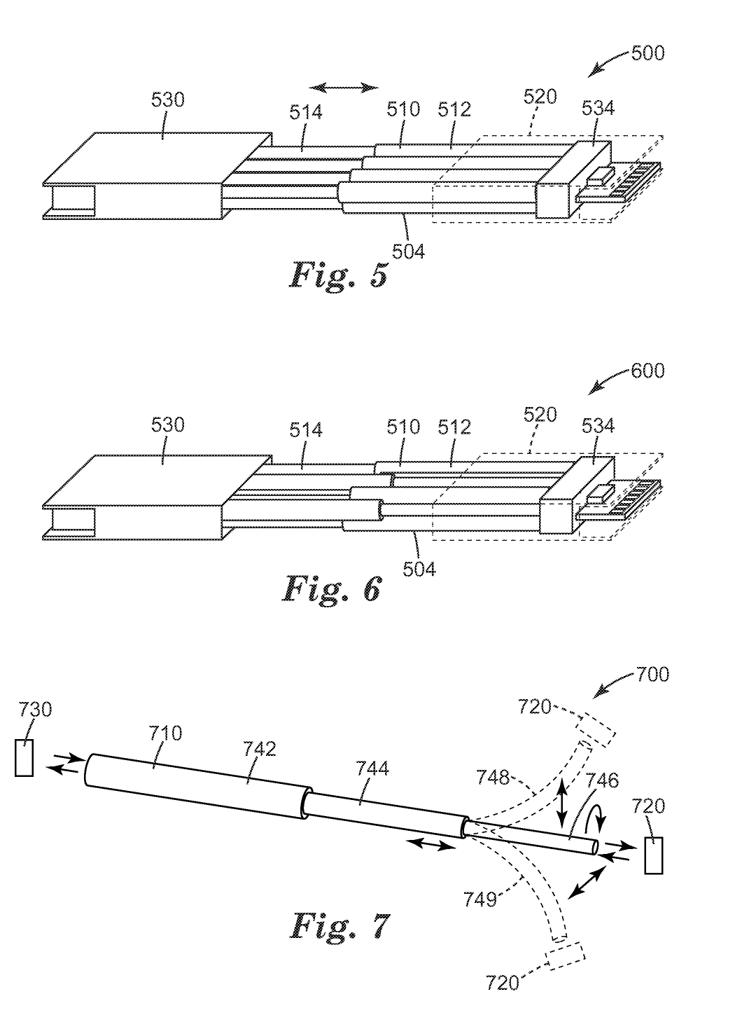

FIG. 5 illustrates one embodiment of a telescoping wireless connector 500 in an electronic system including an array of telescoping waveguides. The connector 500 employs an array 504 of telescoping waveguides 510, where each telescoping waveguide includes a first guiding section 512 and a second guiding section 514 that fits within the first guiding section in a sliding relationship. As a result, the connector 500 can change from an elongated configuration to a more compressed configuration.

The connector 500 also includes a first housing 520 on one end of the telescoping waveguide array and a second housing 530 on the opposite end of the telescoping waveguide array. The first housing 520 is shown in dashed lines and encloses an array of first wireless communication devices 534 that are each in communication with one of the telescoping waveguides 510. The first wireless communication devices 534 are positioned on a paddle card that is configured to slide into a mating connector that provides a modulated signal and power. The second housing 530 is similarly structured, and encloses an array of second communication devices, where each second communication device is in communication with one of the telescoping waveguides 510.

The wireless connector 600 of FIG. 6 also includes first and second housings 520 and 530 and also includes multiple telescoping waveguides 510, each having a first guiding section 512 and a second guiding section 514. The wireless connector 600 differs from the wireless connector 500 of FIG. 5 by alternating the positions of the first and second guiding sections, so that some of the larger first guiding sections 512 are attached to the first housing 520 and some are attached to the second housing 530. This embodiment allows the halves of the wireless connector to be closer and more balanced in size.

In the connectors 500 and 600, crosstalk is addressed by physically isolating the channels using the waveguides themselves. In one embodiment, the telescoping waveguides comprise a metal structure to assist with isolating the channels and reducing crosstalk. In another embodiment, a separator structure including a metal is used between the channels. Also, since the links are generally farther apart than the connection distance without the waveguides and limited power from adjacent channels can couple into the guide from adjacent channels, the crosstalk is naturally limited with these structures.

FIG. 7 illustrates another embodiment of a wireless connector including a telescoping waveguide, where at least a portion of the waveguide is flexible. In some embodiments, a flexible guiding section of the waveguide is more flexible than a more rigid adjacent guiding section of the waveguide.

As used herein, the term flexible means that a waveguide can be bent around a radius of 1 meter or less without a permanent change in cross-section. In some embodiments, a flexible waveguide can be bent around a radius of 1 meter or more without damage to the waveguide or its ability to transmit a wave. In some embodiments, a flexible waveguide can be bent around a radius of 10 centimeters or more without damage to the waveguide or its ability to transmit a wave. In some embodiments, a flexible waveguide can be bent around a radius of 1 centimeter or more without damage to the waveguide or its ability to transmit a wave. In some embodiments, a flexible waveguide can be bent around a radius of 25 millimeters or more without damage to the waveguide or its ability to transmit a wave.

In some embodiments, a flexible waveguide can be bent around the designated repeatedly, such as 100 times or 1000 times, without a permanent change in cross-section.

In some embodiments, a flexible guiding section of the waveguide is more flexible than an adjacent more rigid guiding section of the waveguide. Bending stiffness is one way to measure the stiffness, or lack of flexibility, of a waveguide. The bending stiffness EI of a beam relates the applied bending moment to the resulting deflection of the beam. It is the product of the elastic modulus E of the beam material and the area moment of inertia I of the beam cross-section. Per elementary beam theory, the relationship between the applied bending moment M and the resulting curvature κ of the beam is:

M=EIκ=EI(d²w/dx²)

Where w is the deflection of the beam and x is the spatial coordinate.

In some embodiments, the bending stiffness EI of a flexible guiding section is one-half or less the bending stiffness of an adjacent more rigid guiding section. In some embodiments, the bending stiffness EI of a flexible guiding section is one-tenth or less the bending stiffness of an adjacent more rigid guiding section. The bending stiffness of each guiding section can be measured with a bending test, or determined with a formula, as is known by those of skill in the art.

FIG. 7 shows an expanded configuration of a wireless connector 700 including a telescoping waveguide 710. The wireless connector 700 includes a first communication device 720 configured to emit a modulated signal and a second communication device 730 configured to receive a modulated signal. In one embodiment, both the first and second communication devices 720, 730 are transceivers that are configured to both emit and receive a modulated signal.

The telescoping waveguide 710 is configured to expand to an increase length or contract to a decreased length. The waveguide 710 is positioned between the first and second communication devices 720, 730 and configured to wirelessly receive the emitted modulated signal from a first end of the telescopic waveguide, guide the received signal from the first end to an opposite second end of the telescopic waveguide, and wirelessly transmit the guided signal from the second end to the second communication device.

The waveguide 710 includes at least two guiding sections. Each guiding section is configured to slide within or over an adjacent guiding section inwardly to reduce a length of the telescopic waveguide and outwardly to increase the length of the telescopic waveguide. At least one guiding section defines a cavity along a length of the guiding section to receive an adjacent guiding section. In some embodiments, the telescopic waveguide 710 is centered on an axis and each guiding section is also centered on the axis.

In the embodiment of FIG. 7, the waveguide 710 includes three guiding sections: a first guiding section 742, a second guiding section 744 and a third guiding section 746. The second guiding section 744 is configured to slide within the first guiding section 742 and the third guiding section 746 is configured to slide within the second guiding section 744.

The telescopic waveguide includes a first end guiding section facing the first communication device and an opposing second end guiding section facing the second communication device. In some embodiments, at least one of the first and second end guiding sections is flexible. In the embodiment of FIG. 7, the third guiding section 746 near first communication device 720 is flexible, and is illustrated in different possible configuration including position 748 and position 748 where it is flexed to allow the first communication device 720 to be in a different position.

In some embodiments, the first guiding section 710 is flexible in addition to or instead of the third guiding section being flexible.

In some embodiments, one or more of the end guiding sections is twistable. As used herein, the term twistable means that while one end of a waveguide is held fixed, the other end of the waveguide can be rotated without resulting in a permanent change in cross-section of the waveguide.

In another embodiment, one of the guiding sections is configured to rotate freely within and with respect to another guiding section. In one embodiment, a flexible guiding section is configured to rotate freely within and with respect to an adjacent guiding section.

The flexible guiding section or sections are solid or hollow polymer material in some embodiments, with or without metallization on the outside. In one embodiment, the second guiding section 744 is a hollow metal tube while the flexible third guiding section is a solid polymer rod. Other material options for the guiding sections of connector 700 discussed herein are also possible.

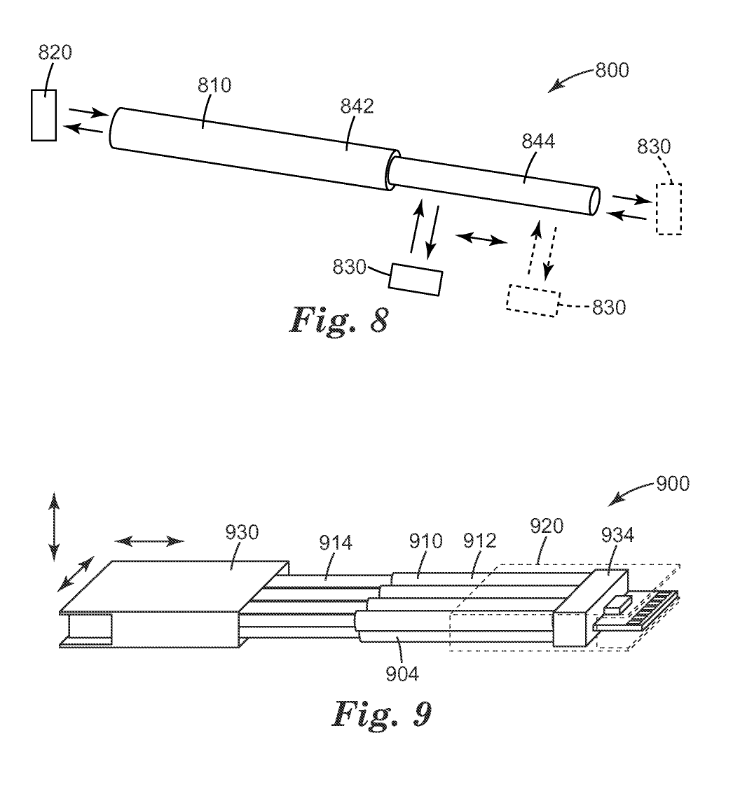

FIG. 8 illustrates another embodiment of a wireless connector 800 including a telescoping waveguide, where the signal is injected or extracted along the side of the waveguide. The wireless connector 800 includes a telescoping waveguide 810, a first communication device 820 configured to emit a modulated signal and a second communication device 830 configured to receive a modulated signal. In one embodiment, both the first and second communication devices 820, 830 are transceivers that are configured to both emit and receive a modulated signal. A portion 844 of the waveguide 810 is made of a material, such as polymer, that allows some penetration of a modulated signal along the side of the portion 844. As a result, the second communication device 830 can be positioned along the side of the guiding portion 844. Also the second communication device 830 can move relative to the portion 844 and still remain in communication with the waveguide 810.

The telescoping waveguide 810 is configured to expand to an increase length or contract to a decreased length. The waveguide 810 is positioned between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device 830, or wirelessly transmit the guided signal to through the side of guiding section 844 to second communication device 830. Three alternate positions for second communication device 830 are illustrated in FIG. 8, and others are possible.

The waveguide 810 includes at least two guiding sections: first guiding section 842 and second guiding section 844. The second guiding section 844 is configured to slide within the first guiding section 842.

To enable the side injection and extraction of the modulated signal, the second guiding section 844 is not made of metal. In one embodiment, the second guiding section is a solid or hollow polymer material. Other material options for the guiding sections of connector 800 discussed herein are also possible.

FIG. 9 illustrates another embodiment of a wireless connector 900 including an array of telescoping waveguides, where at least one guiding portion of each waveguide is flexible. As a result, sliding as well as bending between the two halves is possible. The flexibility allows communication to occur despite relative motion or misalignment due to tolerance or other issues.

The connector 900 employs an array 904 of telescoping waveguides 910, where each telescoping waveguide includes a first guiding section 912 and a second guiding section 914 that fits within the first guiding section in a sliding relationship. As a result, the connector 900 can change from an elongated configuration to a more compressed configuration.

The connector 900 also includes a first housing 920 on one end of the telescoping waveguide array and a second housing 930 on the opposite end of the telescoping waveguide array. The first housing 920 is shown in dashed lines and encloses an array of first wireless communication devices 934 that are each in communication with one of the telescoping waveguides 910. The first wireless communication devices 934 are positioned on a paddle card that is configured to slide into a mating connector that provides a modulated signal and power. The second housing 930 is similarly structured, and encloses an array of second communication devices, where each second communication device is in communication with one of the telescoping waveguides 910.

In the embodiment of FIG. 9, the second guiding sections 914 near the second housing 930 are more flexible than the first guiding sections 912. The flexible guiding sections are solid or hollow polymer material in some embodiments, with or without metallization on the outside. In one embodiment, the first guiding section 912 is a hollow metal tube while the more flexible second guiding section 914 is a solid polymer rod. Other material options for the guiding sections of connector 900 discussed herein are also possible.

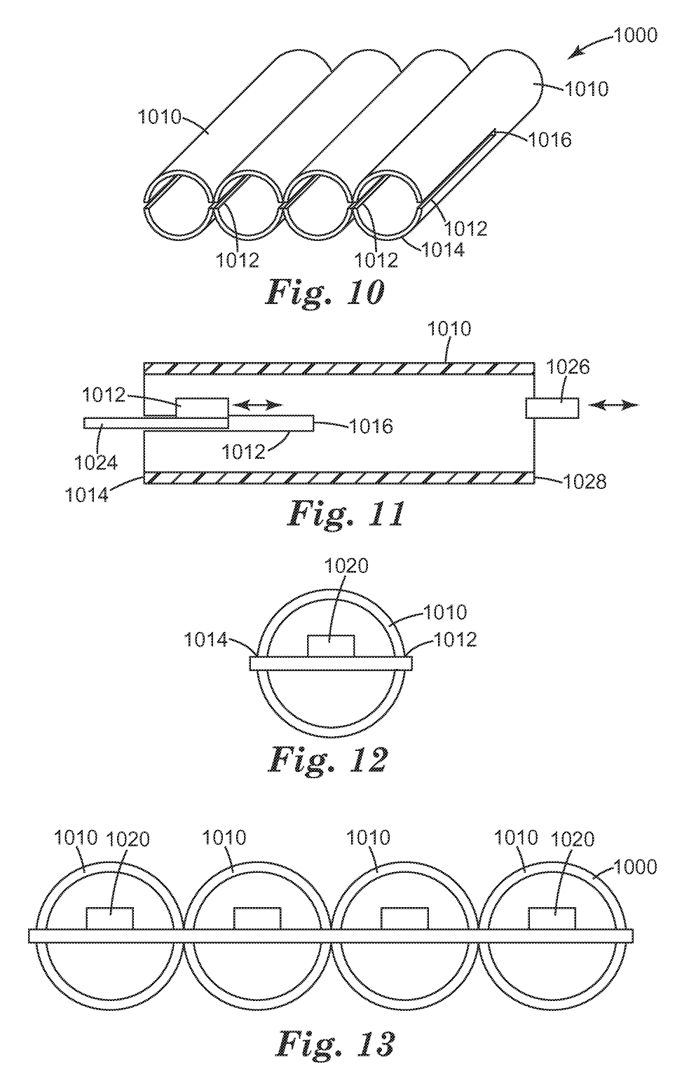

FIG. 10 illustrates an embodiment of an array 1000 of waveguides 1010 that each define slots 1012, 1013. Each slot 1012, 1013 extends from a first end 1014 of a waveguide to a termination point 1016. The slot 1012 is positioned opposite the slot 1013 on the waveguide 1010. As show in FIGS. 11 and 12, this slotted configuration enables a first communication device 1020 on a substrate 1024 to be positioned within the waveguide 1010, even though the substrate is larger than a width of the waveguide. As a result, the first communication device 1020 can emit a modulated signal that can be received by a second communication device 1026 located near a second end 1028 of the waveguide 1010.

Relative motion between the first communication device 1020 and second communication device 1026 is enables because the substrate 1024 can occupy a range of positioned by sliding within the slot 1012. Also, the second communication device 1026 can occupy a range of positions by sliding within and near to the second end 1028 of the waveguide 1010.

Now referring to FIG. 13, the array 1000 of slotted waveguides 1010 can be used to accommodate a substrate 1024 holding multiple first communication devices 1020. Each of the first communication devices is positioned within and associated with one slotted waveguide 1010. Each waveguide 1010 is configured to wirelessly receive the modulated signal emitted by the associated first communication device 1020 from a first end 1014 of the waveguide 1010, guide the received signal from the first end 1014 to an opposite second end 1028 of the waveguide 1010, and wirelessly transmit the guided signal from the second end 1028 of the waveguide to the second communication device 1026. Each of the waveguides 1010 defines a cavity along a length of the waveguide 1010.

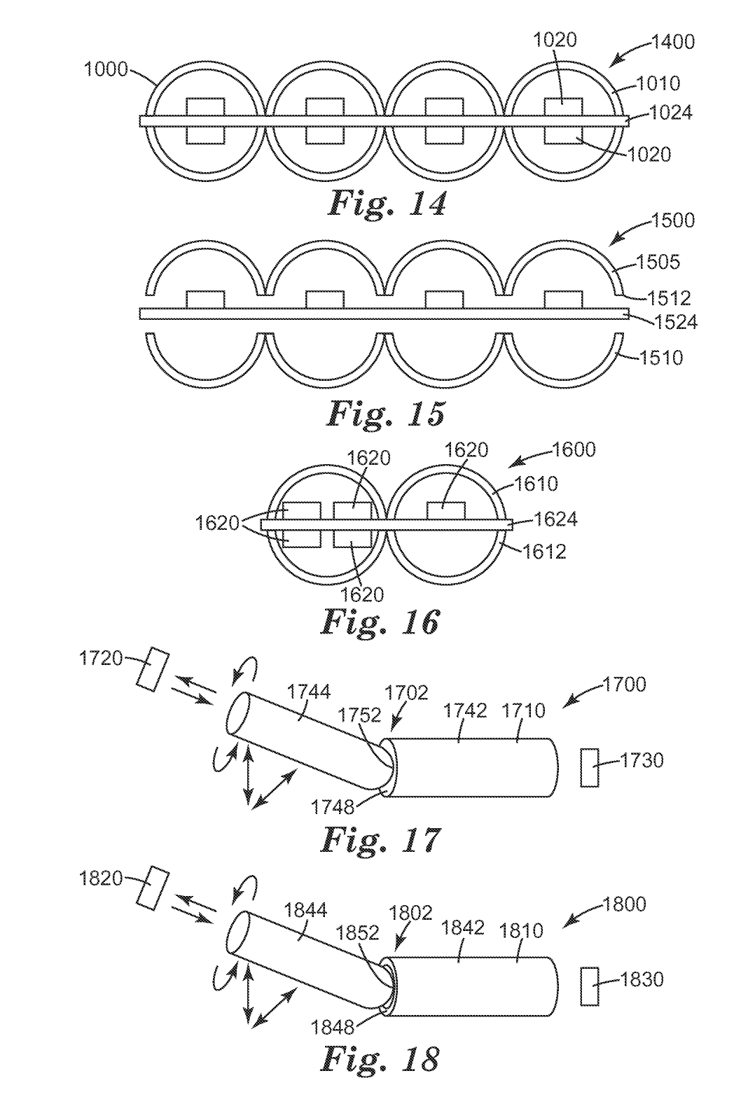

FIG. 14 is an end view of one embodiment of a wireless connector 1400 including an array 1000 of multiple slotted waveguides 1000 with a PCB positioned partially within the slotted waveguides 1000. The PCB includes a substrate 1024 and first communication devices 1020 on both sides of the substrate 1024. As a result, each waveguide 1010 is associated with two first communication devices

FIG. 15 is an end view of one embodiment of a wireless connector 1500 that includes an array 1505 of multiple slotted waveguides 1510. Each waveguide 1510 defines two slots 1512 which are on opposite sides of each waveguide 1510. The slots 1510 are wider than the slots illustrated in FIGS. 10-14, and as a result, only partial walls are present between waveguides. A PCB positioned partially within the slotted waveguides includes a plurality of first communication devices 1520 positioned on a substrate 1524.

FIG. 16 is an end view of one embodiment of a wireless connector 1600 that includes two slotted waveguides 1610 with a PCB positioned partially within the slots 1612 of the waveguides 1610. The PCB includes five first communication devices 1620 positioned on a substrate 1624. A first waveguide 1610 is associated with four first communication devices 1620, where two first communication devices 1620 are positioned on each side of the substrate 1624. Another first waveguide 1610 is associated with a single first communication device 1620.

FIG. 17 illustrates an embodiment of a wireless connector 1700 including a ball and socket joint 1702 positioned between waveguide sections in a waveguide 1710. The wireless connector 1700 includes a first communication device 1720 configured to emit a modulated signal and a second communication device 1730 configured to receive a modulated signal. In one embodiment, both the first and second communication devices 1720, 1730 are transceivers that are configured to both emit and receive a modulated signal.

The waveguide 1710 is positioned between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device.

In the embodiment of FIG. 17, the waveguide 1710 includes two guiding sections: a first guiding section 1742 that is solid and a second guiding section 1744 that may or may not define a cavity. The first guiding section 1742 includes a socket portion 1748 at one end. The second guiding section 1744 includes a ball portion 1750 at one end. The socket portion 1748 receives the ball portion 1750 of the second guiding section to form a ball and socket joint 1702. The ball and socket joint allows for a wide range of movement of that end of the waveguide 1710, so that the position of the first communication device 1720 also enjoys a wide range of movement.

FIG. 18 illustrates a similar embodiment of a wireless connector 1800 including a ball and socket joint 1802 positioned between waveguide sections in a waveguide 1810, but where one of the guiding sections is hollow so telescoping movement is also possible. The wireless connector 1800 includes a first communication device 1820 configured to emit a modulated signal and a second communication device 1830 configured to receive a modulated signal. In one embodiment, both the first and second communication devices 1820, 1830 are transceivers that are configured to both emit and receive a modulated signal.

The waveguide 1810 is configured to expand to an increase length or contract to a decreased length. The waveguide 1810 is positioned between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device.

In the embodiment of FIG. 18, the waveguide 1810 includes two guiding sections: a first guiding section 1842 defining a cavity and a second guiding section 1844 that may or may not define a cavity. The second guiding section 1844 is configured to slide within the first guiding section 1842. The first guiding section 1842 includes a socket portion 1848 at one end. The second guiding section 1844 includes a ball portion 1850 at one end. The socket portion 1848 receives the ball portion 1850 of the second guiding section to form a ball and socket joint 1802. The ball and socket joint allows for a wide range of movement of that end of the waveguide 1810, so that the position of the first communication device 1820 also enjoys a wide range of movement.

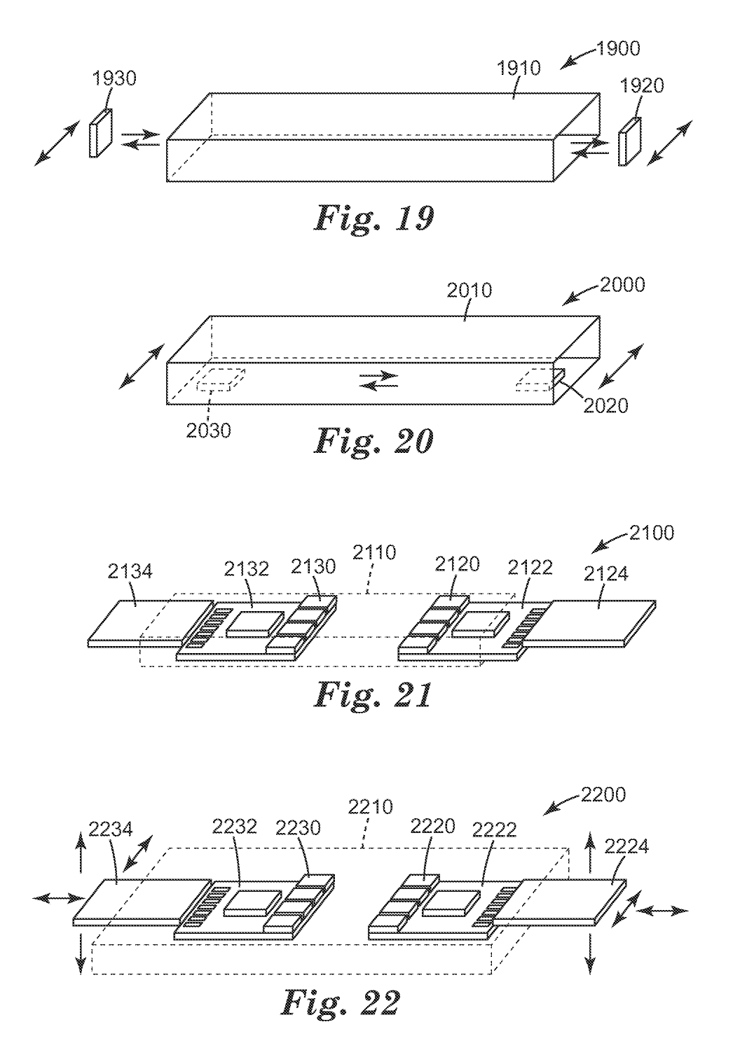

FIG. 19 illustrates one embodiment of a wireless connector 1900 including a waveguide 1910 that is wider than an antenna on a transceiver on a first communication device 1920 or a second communication device 1930. As a result, each communication device 1920, 1930 can have a range of movement and still be in communication with the waveguide 1910. Each communication device 1920, 1930 includes an antenna which emits, receives, or both emits and receives modulated signals. Each antenna emits a field, which can be shaped by nearby reflectors such as ground planes. In one combination of antenna and ground plane in the printed circuit board on which the emitter chip is mounted, the field is launched at a roughly 45 degree angle from the base plane and shaped as a cylinder or widening cone as it progresses away from the source. At some distance the field strength is reduced to a level that is below the threshold level to trigger sufficient reception by a receiver placed at that distance. For the communication device to be in communication with the waveguide, the field produced by the antenna has a sufficient overlap with an end of the waveguide. The provision of a waveguide 1910 with a width larger than the antenna increases the range of relative positions that can be occupied by the waveguide and the communication devices.

FIG. 20 illustrates another embodiment of a wireless connector 2000 including a waveguide 2010 and two communication devices 2020 or 2030, where the communication devices are positioned within the waveguide 2010. The waveguide maybe hollow throughout, or may have cavities defined at each of the waveguide ends to accommodate the communication devices 2020, 2030. The communication devices can move within the hollow spaces at the ends of the waveguide 2010 and still maintain communication with the waveguide.

FIG. 21 illustrates one embodiment of a wireless connector 2100 including a waveguide 2110 that accommodates multiple communication devices at each end. The waveguide 2110 is shown in dashed lines so that the communication devices within the waveguide can be more easily illustrated. Multiple first communication devices 2120 are located within or at a first end of the waveguide 2110 and are situated on a substrate 2122. A cable 2124 is connected to the substrate 2122 and is in communication with the first communication devices 2120. The first communication devices 2120 emit, receive or both emit and receive modulated signals to or from which are propagated in the waveguide 2110. Second communication devices 2130 are located within a second end of the waveguide 2110 and are positioned on a substrate 2132 connected to a cable 2134. The waveguide 2110 is positioned between the first communication devices and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device.

FIG. 22 illustrates one embodiment of a wireless connector 2200 including a waveguide 2210 which accommodates multiple communication devices at each end, which is similar in many ways to wireless connector 2100 of FIG. 21. FIG. 22 additionally allows for relative motion of the communication devices within waveguide 2210 as the waveguide 2210 is hollow or defines cavities at its ends. The waveguide 2210 is shown in dashed lines so that the communication devices within the waveguide can be more easily illustrated. Multiple first communication devices 2220 are located within or at a first end of the waveguide 2210 and are situated on a substrate 2222. A cable 2224 is connected to the substrate 2222 and is in communication with the first communication devices 2220. The first communication devices 2220 emit, receive or both emit and receive modulated signals to or from which are propagated in the waveguide 2210. Second communication devices 2230 are located within a second end of the waveguide 2210 and are positioned on a substrate 2232 connected to a cable 2234. The substrates 2222, 2232 and therefore the communication devices can be moved within the waveguide and near the ends of the waveguides and still maintain communication with the ends of the waveguide.

The waveguide 2210 is positioned between the first communication devices and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device.

The wireless connectors 2100, 2200 have arrays of communication devices that are networked so that the waveguides 2110, 2210 can be used to guide multiple channels along its length.

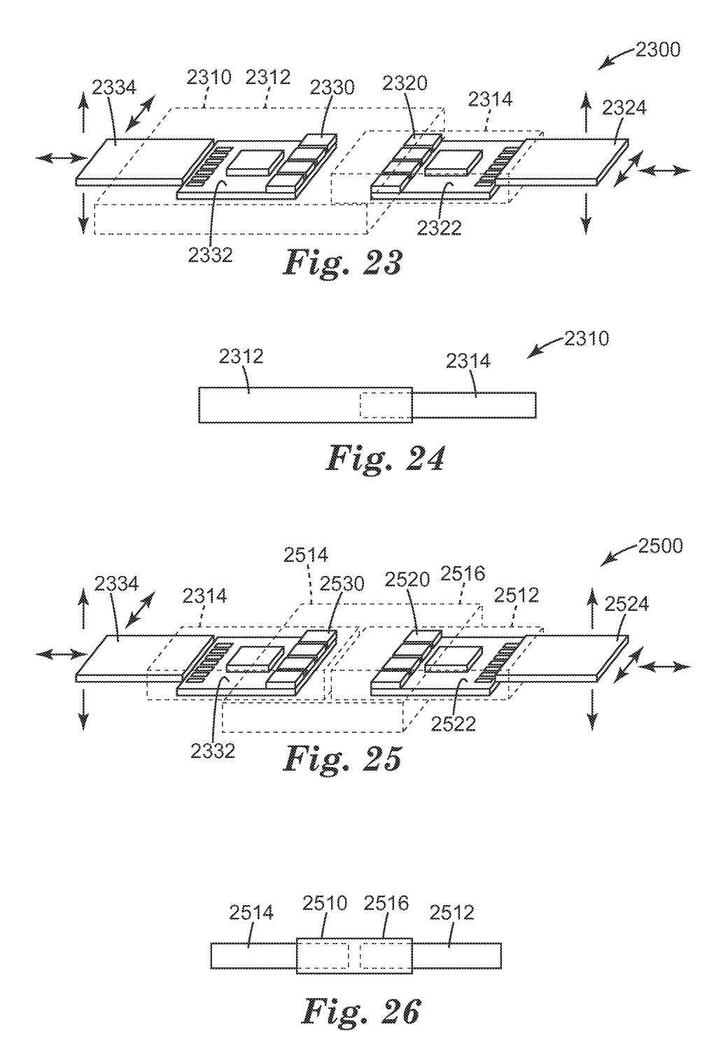

FIGS. 23 and 24 illustrate one embodiment of a wireless connector 2300 including a housing 2310 that has an outer enclosure 2312 and an inner enclosure 2314 that are capable of relative movement. As a result the housing is capable of extended or compressed configurations.

The outer enclosure 2312 is hollow to accommodate the inner enclosure 2314. In FIG. 23, the housing 2310 is shown in dashed lines so that the communication devices within the housing and the relative motion of the housing portions can be more easily illustrated. In FIG. 24, the housing 2310 is shown alone in a side view to illustrate how the outer enclosure 2312 fits over the inner enclosure 2314. Multiple first communication devices 2320 are located within or at a first end of the housing 2310 and are situated on a substrate 2322. A cable 2324 is connected to the substrate 2322 and is in communication with the first communication devices 2320.

Also, included in the wireless connector 2300 but not shown in FIG. 23 for the sake of simplicity, a telescoping waveguide array provides communication between the first and second communication devices 2320, 2330. Some embodiments of waveguide arrays that may be used with the connector 2300 are shown in FIGS. 5, 6 and 9, herein. The embodiment of FIGS. 23-24 is illustrated with an array of first communication devices 2320 and an array of second communication devices 2330. Another embodiment includes just a single first communication device and a single second communication device that are connected by a single wave guide structure. The waveguide is positioned between the first communication devices and second communication devices and is configured to wirelessly receive one or more emitted modulated signals from a first end of the telescopic waveguide, guide the received signal or signals from the first end to an opposite second end of the telescopic waveguide, and wirelessly transmit the guided signal from the second end to the second communication devices.

FIG. 25 illustrates another embodiment of a wireless connector 2500 that is expandable in length and can accommodate multiple sets of communication devices. The wireless connector 2500 includes a housing 2510 including first and second inner enclosures 2512, 2514 and a third outer enclosure 2516. The enclosures 2512, 2514, 2516 are capable of relative movement to allow the housing 2510 to have expanded or contracted configurations. FIG. 26 is a side view of the first, second and third enclosures 2512, 2514, 2516 of FIG. 25, which form the housing 2510.

The outer guiding section 2516 is hollow along its length to accommodate the first and second inner enclosures 2512, 2514. In FIG. 25, the housing 2510 is shown in dashed lines so that the communication devices within the housing and the relative movement of the enclosures can be more easily illustrated. The first and second guiding sections 2512, 2514 may be hollow along their lengths to accommodate the communication devices and a waveguide, not shown. Multiple first communication devices 2520 are located within or at a first end of the housing 2510 and are situated on a substrate 2522. A cable 2524 is connected to the substrate 2522 and is in communication with the first communication devices 2520. Multiple second communication devices 2530 are located within or at a second end of the housing 2510 and are situated on a substrate 2532. A cable 2524 is connected to the substrate 2522 and is in communication with the second communication devices 2530.

Also, included in the wireless connector 2500 but not shown in FIG. 25 for the sake of simplicity, a telescoping waveguide array provides communication between the first and second communication devices 2520, 2530. Some embodiments of telescoping waveguide arrays that may be used with the connector 2500 are shown in FIGS. 5, 6 and 9, herein. The embodiment of FIGS. 25-26 is illustrated with an array of first communication devices 2320 and an array of second communication devices 2330. Another embodiment includes just a single first communication device and a single second communication device that are connected by a single wave guide structure located within the housing 2510. The waveguide is positioned between the first communication devices and second communication devices and is configured to wirelessly receive one or more emitted modulated signals from a first end of the telescopic waveguide, guide the received signal or signals from the first end to an opposite second end of the telescopic waveguide, and wirelessly transmit the guided signal from the second end to the second communication devices.

The housings 2300, 2500 enclose arrays of communication devices that are networked so that the waveguides 2110, 2210 can be used to guide multiple channels along its length.

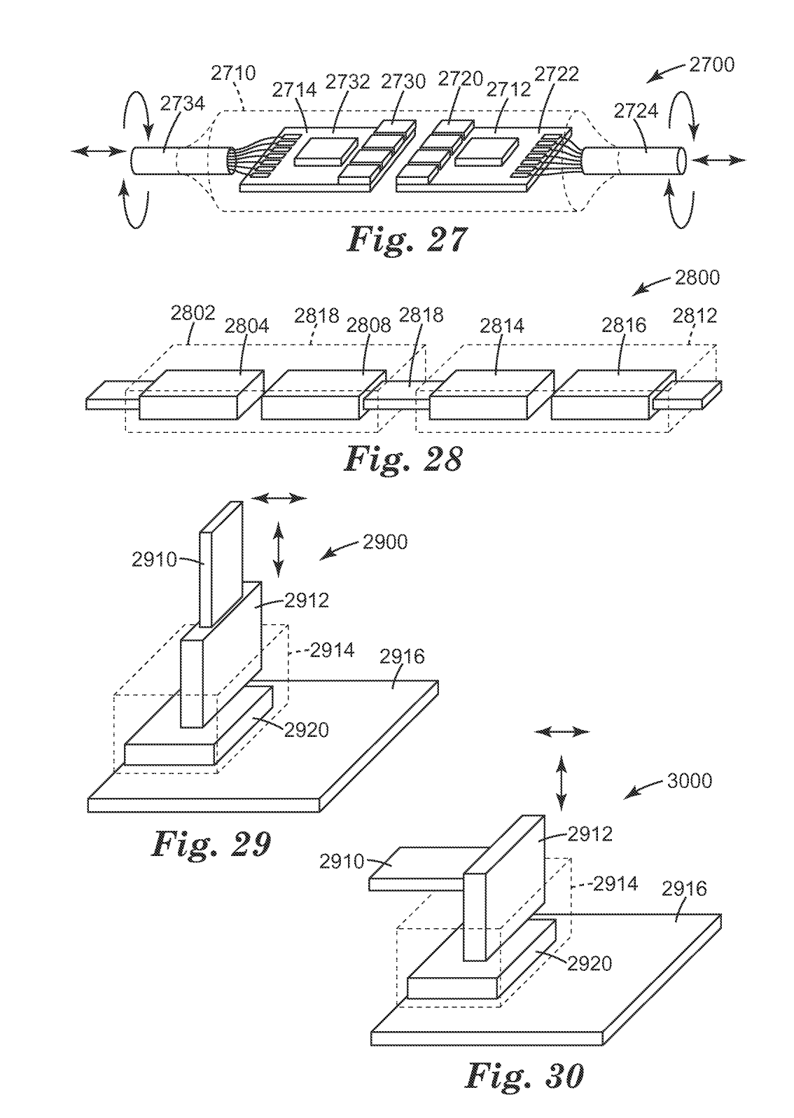

FIG. 27 is a perspective view of one embodiment of a wireless connector 2700 including a waveguide 2710 that encloses two PCBs 2712, 2714, and accommodates relative lateral and rotational motion between the two PCBs 2712, 2714. The waveguide 2710 is cylindrical and hollow, though other shapes are possible as long as the interior dimension of the waveguide are large enough to accommodate the rotational and lateral movement of the PCBs 2712, 2714. For example, the waveguide could have a rectangular cross-section or an elliptical cross-section. In another embodiment, the waveguide has a telescoping construction.

Multiple first communication devices 2720 are located on a first PCB 2712 within a first end of the waveguide 2710 and are situated on a substrate 2722. A cable 2724 is connected to the substrate 2722 and is in communication with the first communication devices 2720. Multiple second communication devices 2730 are located within a second end of the waveguide 2710 and are situated on a substrate 2732. A cable 2724 is connected to the substrate 2722 and is in communication with the second communication devices 2730.

In the embodiment of FIG. 27, the cables 2724, 2734 are round and this shape facilitates the rotation of the cables and PCBs 2712, 2714 within the hollow waveguide 2710.

The waveguide 2710 is positioned between the first communication devices and second communication devices and is configured to wirelessly receive one or more emitted modulated signals from a first end of the telescopic waveguide, guide the received signal or signals from the first end to an opposite second end of the telescopic waveguide, and wirelessly transmit the guided signal from the second end to the second communication devices.

The wireless connector 2700 includes two arrays of communication devices that are networked so that the waveguide 2710 can be used to guide multiple channels along its length.

Many embodiments include multiple channels of communication between sets of communication devices within a single waveguide, such as the embodiments of FIGS. 16 and 21-27. These embodiments have arrays of communication devices that are networked so that the waveguide can be used to guide multiple channels along its length. The waveguide structure allows the signal to be carried further than if the guide was not present. The waveguide also tends to contain the field and the network to a defined location so that other similar networks can be placed nearby.

Waveguides described herein may have many different shapes and be made of many different materials, as described herein.

FIG. 28 is a perspective view of one embodiment of a system 2800 where multiple wireless connectors are used to allow relative movement of multiple transceivers. A first wireless connector system 2802 includes a first waveguide 2804. A first PCB 2806 including one or more communication devices is contained within one end of the first waveguide 2804. A second PCB 2808 including one or more second communication devices is contained within a second end of the first waveguide 2804. The waveguide 2804 is hollow and allows for relative motion of the PCBs 2806, 2808. Similarly, a second wireless connector system 2810 includes a second waveguide 2812 that is hollow and accommodates a third PCB 2814 and a fourth PCB 2816, where each PCB includes one or more communication devices. A cable 2818 connects the second PCB 2808 and third PCB 2814.

In one embodiment, the communication devices are configured to emit and receive a modulated signal. The waveguides are each configured to receive a modulated signal emitted by a communication device at a first end of the waveguide and guide the signal to the second end of the waveguide, and wirelessly transmit the signal to another communication device.

By using two wireless connectors 2802, 2810, even more lateral motion is permitted compared to the use of one expandable wireless connector.

FIG. 29 is a perspective view of one embodiment of a wireless connector system 2900 where a cable 2910 has a PCB 2912 at a terminated end of the cable 2910 with one or more communication devices that are positioned within a hollow waveguide 2914 near a first end of the waveguide 2914. A PCB 2916 is located near an opposite end of the waveguide 2914. The PCB 2916 includes a communication device 2920 that is positioned within the waveguide 2914. The use of hollow waveguide 2914 allows for some relative motion between the end of the cable 2910 and the PCB 2916 without degrading the connection. The waveguide 2914 can also serve to shield or attenuate the wireless radiation. The wireless channels can be configured as either point-to-point or as a network.

FIG. 30 is a perspective view of another embodiment of a wireless connector system 3000, which includes the same basic components as wireless connector system 2900 of FIG. 29, except that in the wireless connector system 3000 the cable 2910 is at a right angle to the PCB 2912.

Electronic systems routinely connect printed circuit boards (PCBs) via copper or optical cables. At high data rate transmissions, copper cables suffer from well-known problems of electromagnetic emissions (EMI), signal loss and signal crosstalk. To use optical cables, the PCBs need additional hardware on the PCBs to convert electrical signals to optical signals and vice versa (E/O conversion). However, the limited space on PCBs makes it very hard to place the needed E/O conversion hardware on a PCB.

One approach to address issues of limited PCB real estate is to use active-optical cables. Such cables directly connect to the existing electrical connectors on a PCB. The E/O conversion is performed within the cable where an optical signal is generated and transmitted on an optical cable. On the other end of the cable, the optical signal is received and converted back to the electrical signal and delivered to the receiving PCB.

Active-optical cables may also be used at lower frequencies. For example, the 60 GHz band has many properties similar to optical frequencies, such as line-of-sight transmission, and license-free communications. Helpfully, the radiating structures are of very small sizes and. many such 60 GHz integrated circuits (ICs) are available commercially. Wireless communication can transmitted on any suitable carrier frequency, but frequencies within the EHF band of 30-300 GHZ, such as 60 GHz, can be particularly useful for high bandwidth wireless data transmission. As used herein, the term “60 GHz” refers to the frequency band from about 57 GHz to about 64 GHz.

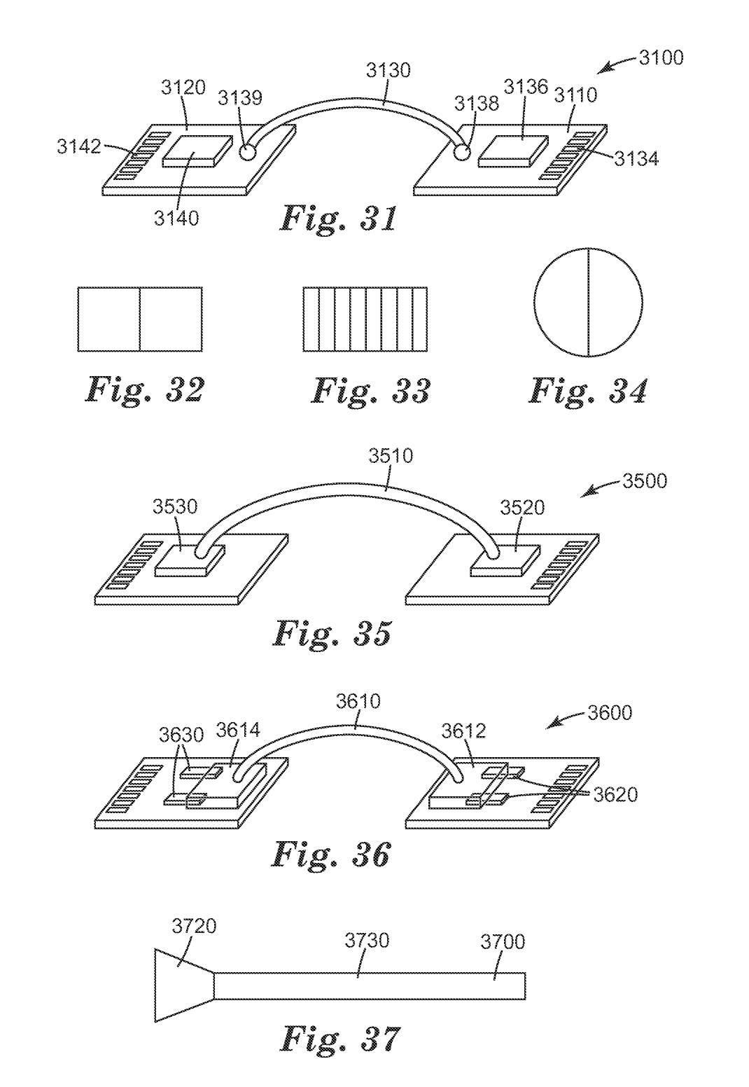

An active cable 3100, also referred to as a wireless connector 3100, as illustrated in FIG. 31 may be designed to connect two PCBs. The wireless connector 3100 includes a first substrate or connector structure 3110 and a second substrate or connector structure 3120 connected to each other via a waveguide 3130. In operation, a first PCB (not shown) is connected to the wireless connector 3100 via electrical connectors 3134. The first PCB delivers a baseband signal to a first end of the waveguide 3130 via the electrical connectors 3134 and the first communication device 3136, such as a transceiver. At the first end of the waveguide, an interface portion 3138 is located. The first communication device 3136 uses the baseband signal to modulate a carrier signal and transmit the carrier signal over the waveguide 3130 to a second end of the waveguide 3130. The second substrate 3120 includes a second communication device 3140 and electrical connectors 3142. The second end of the waveguide 3130, at second interface portion 3139, receives the modulated carrier signal and the second communication device 3140, such as a transceiver, demodulates it back to the baseband signal. The connector system then delivers the baseband signal to PCB 2 via the electrical connectors 3142.

In some embodiments, a modulated signal emitted by the first communication device comprises a plurality of carrier signals, each carrier signal having a different frequency and being modulated with a digital signal. The digital signal includes a time multiplexed signal in some embodiments.

Active cable or wireless connector configurations using waveguides are very attractive as they can potentially increase the coupling range of two very low powered ICs. A 60 GHz active cable system is mentioned as only one example of active cable systems. Many other millimeter-wave frequencies (e.g. 77 GHz) may also be employed using the same principle.

The waveguide 3130 that may be used in a wireless connector may include hollow metal structures, dielectric-filled metal structures, a dielectric hollow structure, a dielectric solid structure, multiple dielectric hollow structures fused together or isolated by metal isolates, or multiple dielectric slabs fused together or isolated by metal isolates. The waveguide may have a rectangular, circular or elliptical cross section. Solid dielectric structures and hollow dielectric structures can incorporate higher and lower dielectric material cladding for better guiding the energy along with waveguide.

In some cases, waveguide structures can be partially filled with dielectric materials for providing simultaneous communication between multiple channels. FIGS. 32 to 34 are examples of cross-sections of metal waveguides partially filled with dielectric material. For FIGS. 32 and 34, one half of the structure can be filled with one dielectric material while the other half is filled with air or another dielectric material. For FIG. 33, each section can be filled with dielectric material that is different from the dielectric material of adjacent sections.

One challenging aspect of using a 60 GHz wireless connector originates from the way 60 GHz signal is generated and radiated using existing ICs. Due to very high conductor loss, all commercially available 60 GHz chips integrate antennas within the IC structure and are not accessible outside the chips. Coupling such ICs to a waveguide can be very challenging. The signal radiated by the ICs and incident upon the waveguide may be a spherical wave, a plane wave or it may even passively couple to a waveguide. The signal propagating within the waveguide is in the form of discrete waveguide modes with configurations dictated by the waveguide structure and dimensions. In short, the RF signals within the waveguide and the RF signals radiated/coupled by the 60 GHz IC differ significantly both in their configurations and their propagating properties. For example, both signals may have significantly different wave impedances.

When two structures carrying signals with significantly different wave impedances are connected together, significant reflections occur at the interface/junction of the two structures. This means that within an RF active cable/connector, significant amount of RF energy will be reflected by the waveguide structure back to the air or the medium where 60 GHz IC is located. These reflections, when significant, will lead to serious signal integrity issues including poor signal energy transmission within the 60 GHz active cable/connector. Crosstalk issues will also arise if multiple ICs are being coupled by the 60 GHz active cable/connector. This scenario necessitates designing interfaces that efficiently couple signals radiated/coupled by 60 GHz ICs to the waveguide modes within the active cables/connectors.

FIG. 35 illustrates one embodiment of a structure that improves the efficient interfacing of transceivers to waveguides within wireless connectors. FIG. 35 shows a wireless connector 3500 including a waveguide 3510 directly fused to a first communication device 3520 at one end and to a second communication device 3530 at the opposite end. In one embodiment, each end of the waveguide 3510 covers the entire corresponding communication device. In another embodiment, each end of the waveguide 3510 partially covers the corresponding communication device. The waveguide 3510 is connected to each communication device 3520, 3530 so that the waveguide end covers the radiating elements of the communication device. This improves the coupling of the energy into the waveguide structure and reduces reflections.

FIG. 36 illustrates one embodiment of a wireless connector 3600 including a waveguide 3610 which has a first waveguide interface structure 3612 at a first end and a second dielectric interface structure 3614 at a second end of the waveguide. Each of the interface structures 3612, 3614 covers a corresponding communication device 3620, 3630 at least partially. The interface structures 3612, 3614 have dielectric properties that are the same or closely matching to those of the material filling the waveguide.

FIG. 37 illustrates one embodiment of a side view of a waveguide 3700 including a dielectric interface end 3720 and a waveguide portion 3730. In this embodiment, the waveguide portion is a hollow metal waveguide that may or may not have a dielectric center portion. Where the waveguide portion 3730 meets the interface end 3720, interface end 3720 has a cross-section that matches the waveguide portion 3730 cross-section. Moving along the length of the interface end 3720 toward where it couples to the air, the interface end 3720 becomes increasingly wide. This configuration improves the impedance matching between free-space waves near the open end to the waveguide modes near the waveguide end. Both the waveguide portion and the interface end may be hollow or filled with a dielectric material.

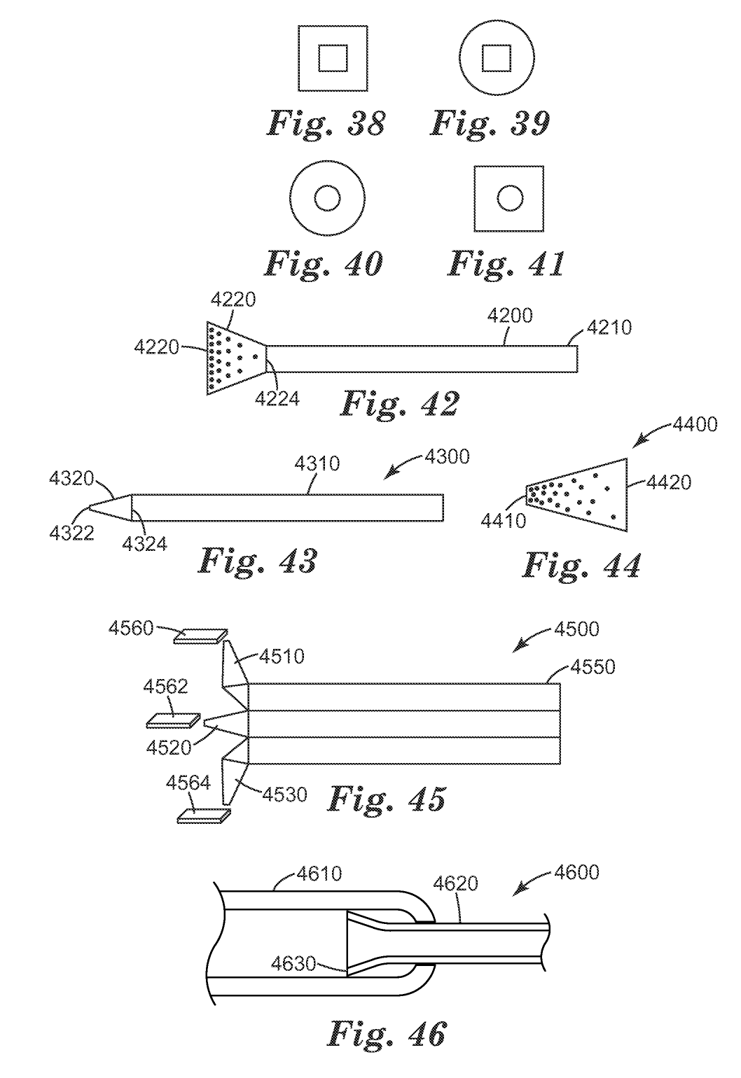

Options for the cross-section of the waveguide will now be discussed. FIG. 38 illustrates one embodiment of an end view of the waveguide of FIG. 37, including a rectangular interface end and a rectangular waveguide end. FIG. 39 illustrates one embodiment of an end view of the waveguide of FIG. 37, including a circular interface end and a rectangular waveguide portion end. FIG. 40 illustrates one embodiment of an end view of the waveguide of FIG. 37, including a circular interface end and a circular waveguide portion end. FIG. 41 illustrates one embodiment of an end view of the waveguide of FIG. 37, including a rectangular interface end and a circular waveguide portion end.

FIG. 42 illustrates a cross-sectional view of one embodiment of a hollow dielectric or metal waveguide 4200 including a waveguide portion 4210 and an interface structure 4220. The interface structure 4220 has a larger diameter at an air interface end 4222 than at a waveguide end 4224. At the waveguide end 4224 of the interface structure 4220, the interface structure 4220 has a cross-section that matches the waveguide portion 4210 cross-section. Moving along the length of the interface structure 4220 toward the air interface end 4222 where it couples to the air, the interface structure 4220 becomes increasingly wide.

If a metal waveguide filled with a dielectric material is employed, the interface structure 4220 also includes bubbles of air or lower permittivity than that of the material surrounding the bubbles. The material surrounding the bubbles has dielectric properties matching closely to the material filling the metal waveguide. Moving along the length of the interface structure 4220 toward the air interface end 4222 where it couples to the air, the bubbles are more densely packed in one embodiment. In one embodiment, the bubbles of air or material of lower permittivity increase in size moving along the length of the interface structure 4220 toward the air interface end 4222. In one embodiment, the air or material of lower permittivity increases in volume percentage moving along the length of the interface structure 4220 toward the air interface end 4222. In some embodiments, the dielectric constant of the interface structure decreases along the length of the interface structure 4420 moving toward the air interface end 4422.

In one embodiment, the waveguide portion 4210 is a metal tube filled with a first dielectric material and the interface structure 4220 is metal filled with a second dielectric material that has properties identical to or closely matching the first dielectric material. The bubbles of air or lower permittivity are present within the second dielectric material of the interface structure.

FIG. 43 illustrates a cross-sectional view of one embodiment of a solid core dielectric waveguide 4300 including a waveguide portion 4310 and an interface structure 4320 that has a smaller diameter at an air interface end 4322 than at a waveguide end 4324. In one embodiment, the waveguide portion 4310 is made of a first dielectric material and the interface structure 4320 includes a second dielectric material that has properties identical to or closely matching the first dielectric material. At the waveguide end 4324 of the interface structure 4320, the interface structure 4320 has a cross-section that matches the waveguide portion 4310 cross-section. Moving along the length of the interface structure 4320 toward the air interface end 4322 where it couples to the air, the interface structure 4320 becomes increasingly narrow.

FIG. 44 illustrates a cross-sectional view of one embodiment of an interface structure 4400 that has a smaller diameter at an air interface end 4410 than at a waveguide end 4420, and having bubbles of air or a low permittivity material. At the waveguide end 4424 of the interface structure 4420, the interface structure 4420 has a cross-section that matches the waveguide portion 4410 cross-section. Moving along the length of the interface structure 4420 toward the air interface end 4422 where it couples to the air, the interface structure 4420 becomes increasingly narrow.

The interface structure 4420 also includes bubbles of air or material with lower permittivity than that of the material surrounding the bubbles. Moving along the length of the interface structure 4420 toward the air interface end 4422 where it couples to the air, the bubbles are more densely packed in one embodiment. The interface structure 4420 is a dielectric material in one embodiment. In one embodiment, the bubbles of air or material of lower permittivity increase in size moving along the length of the interface structure 4420 toward the air interface end 4422. In one embodiment, the air or material of lower permittivity increases in volume percentage moving along the length of the interface structure 4420 toward the air interface end 4422. In some embodiments, the dielectric constant of the interface structure decreases along the length of the interface structure 4420 moving toward the air interface end 4422.

FIG. 45 illustrates a wireless connector 4500 including multiple interface structures 4510, 4520 and 4530 connected to a waveguide portion 4550 having multiple dielectric materials. First, second and third communication devices 4560, 4562, 4564 are positioned near the interface structures 4510, 4520 and 4530, respectively. Each of the interface structures has a narrower end near an air interface end, similar to FIGS. 43 and 44. The air interface end of each interface structure is positioned near a different communication device. The waveguide interface end of each interface structure is located near an area of different dielectric material. This configuration is well-suited for a networked coupling or for spatial multiplexing with multiple dielectric materials layered inside the waveguide structure.

FIG. 46 illustrates a cross-sectional view of a waveguide 4600 having a first guiding section 4610 fitting over a second guiding section 4620. The second guiding section 4620 is configured to slide inwardly and outwardly within the first guiding section 4610. The second guiding section 4620 has a first end 4630 disposed within the first guiding section 4610. The second guiding section becomes increasingly wide in at least one dimension approaching the first end 4630 of the second guiding section 4629. The configuration assists with coupling between the two guiding sections.

The waveguides disclosed herein can guide a received signal from a first end of the waveguide to an opposite second end of the waveguide using any guiding method that may be suitable or available in an application. For example, in some cases, the signal may be guided by transmitting one or more discrete guided modes such as one or more transverse electric (TE) modes, transverse magnetic (TM) modes, or hybrid modes. In some cases, the signal coupled to the waveguide may propagate from the first end of the waveguide to the opposite second end of the waveguide. In some cases, the signal may be guided between the two ends by evanescent coupling.

Following are a list of embodiments of the present disclosure:

Item 1 is a wireless connector comprising:

a first communication device configured to emit a modulated signal;

a second communication device configured to receive the emitted modulated signal; and

a telescopic waveguide disposed between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device, the telescopic waveguide being centered on an axis and comprising a plurality of guiding sections, each guiding section being centered on the axis and configured to slide within or over an adjacent guiding section inwardly to reduce a length of the telescopic waveguide and outwardly to increase the length of the telescopic waveguide.

Item 2 is a wireless connector comprising:

a first communication device configured to emit a modulated signal;

a second communication device configured to receive the emitted modulated signal; and

a telescopic waveguide disposed between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device, the telescopic waveguide comprising a plurality of guiding sections, each guiding section being configured to slide within or over an adjacent guiding section inwardly to reduce a length of the telescopic waveguide and outwardly to increase the length of the telescopic waveguide, wherein at least one guiding section defines a cavity along a length of the guiding section.

Item 3 is the wireless connector of items 1-2, 4-66, wherein the waveguide is tubular and each guiding section is tubular.

Item 4 is the wireless connector of item 3, wherein the cavity of the waveguide is configured to guide the received signal from the first end to an opposite second end of the waveguide.

Item 5 is the wireless connector of item 1-4, 6-66, wherein the modulated signal emitted by the first communication device comprises a carrier signal modulated with a digital signal.

Item 6 is the wireless connector of item 1-5, 7-66, wherein the modulated signal emitted by the first communication device comprises a plurality of carrier signals, each carrier signal having a different frequency and being modulated with a digital signal.

Item 7 is the wireless connector of item 5, wherein the carrier signal has a frequency in a range from 30 to 300 GHz.

Item 8 is the wireless connector of item 5, wherein the carrier signal has a frequency in a range from 57 to 64 GHz.

Item 9 is the wireless connector of item 5, wherein the digital signal comprises time multiplexed digital signals.

Item 10 is the wireless connector of item 1-9, 11-66, wherein the first communication device is disposed on a first printed circuit board (PCB) and the second communication device is disposed on a different second PCB.

Item 11 is the wireless connector of item 1-10, 13-66, wherein the first and second communication devices are disposed in a housing, wherein the housing has a dimension configured to change.

Item 12 is the wireless connector of item 1-10, 13-66, wherein the first communication device is disposed within and stationary relative to a housing and the second communication device is configured to slide into or out of the housing.

Item 13 is the wireless connector of item 1-12, 14-66, wherein the first and second communication devices are coupled through at least one wired connection.

Item 14 is the wireless connector of item 13, wherein the at least one wired connection carries a first signal used to demodulate the modulated signal that is emitted by the first communication device and received by the second communication device.

Item 15 is the wireless connector of item 14, wherein the first signal comprises a clock signal.

Item 16 is the wireless connector of item 1-15, 17-66, wherein the first communication device includes at least one first antenna configured to emit the modulated signal and the second communication device includes at least one second antenna configured to receive the emitted modulated signal.

Item 17 is the wireless connector of item 1-16, 19-66, wherein at least one guiding section in the plurality of guiding sections of the waveguide comprises a solid dielectric waveguide, a hollow dielectric waveguide, or a hollow electrically conductive waveguide.

Item 18 is the wireless connector of item 1-16, 19-66, wherein at least one guiding section in the plurality of guiding sections of the waveguide comprises a solid dielectric core surrounded by an electrically conductive cladding.

Item 19 is the wireless connector of item 1-18, 20-66, wherein the waveguide becomes increasingly wide in at least one dimension approaching at least one end of the telescopic waveguide.

Item 20 is the wireless connector of item 1-19, 21-66, wherein the waveguide further comprises a first guiding section and an adjacent second guiding section, a first end of the first guiding section comprising a ball portion, a second end of the second guiding section comprising a socket portion, the ball portion of the first guiding section being disposed within the socket portion of the second guiding portion and free to move within the socket portion in a plurality of directions.

Item 21 is the wireless connector of item 1-20, 22-35, 40-46, 48-66, wherein the plurality of guiding sections of the waveguide comprises a first guiding section and an adjacent second guiding section being configured to slide inwardly and outwardly within the first guiding section, the second guiding section having an a first end disposed within the first guiding section, the second guiding section becoming increasingly wide in at least one dimension approaching the first end of the second guiding section.

Item 22 is a wireless connector comprising:

a first communication device configured to emit a modulated signal;

a second communication device configured to receive the emitted modulated signal; and

a telescopic waveguide disposed between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device, the telescopic waveguide comprising a first guiding section and a second guiding section configured to slide inwardly within the first guiding section to reduce a length of the telescopic waveguide and outwardly to increase the length of the telescopic waveguide, the second guiding section having a first end disposed within the first guiding section, the second guiding section becoming increasingly wide in at least one dimension approaching the first end of the second guiding section.

Item 23 is the wireless connector of item 1-22, 24-35, 40-46, 48-66, wherein the plurality of guiding sections of the waveguide comprises a first end guiding section facing the first communication device and an opposing second end guiding section facing the second communication device, at least one of the first and second end guiding sections being flexible.

Item 24 is the wireless connector of item 1-23, 25-66, wherein the first communication device is disposed outside the waveguide facing the first end of the waveguide and the second communication device is disposed outside the waveguide facing the second end of the waveguide.

Item 25 is a wireless connector comprising:

a first communication device configured to emit a modulated signal;

a second communication device configured to receive the emitted modulated signal; and

a waveguide centered on an axis and disposed between the first and second communication devices and configured to wirelessly receive the emitted modulated signal from a first end of the waveguide, guide the received signal from the first end to an opposite second end of the waveguide, and wirelessly transmit the guided signal from the second end to the second communication device, the waveguide comprising a first guiding section and a second guiding section, each of the first and second guiding sections being centered on the axis, a first end of the first guiding section comprising a ball portion, a second end of the second guiding section comprising a socket portion, the ball portion of the first guiding section being disposed within the socket portion of the second guiding portion and free to move within the socket portion in a plurality of directions.

Item 26 is the wireless connector of item 25, wherein the second guiding section is disposed between the first guiding section and a third guiding section, the second guiding sections being configured to slide within or over the third guiding section inwardly to reduce a length of the waveguide and outwardly to increase the length of the waveguide.

Item 27 is the wireless connector of item 25, wherein the second guiding section comprises a solid waveguide next to the socket portion.

Item 28 is the wireless connector of item 25, wherein the second guiding section is a hollow waveguide.

Item 29 is the wireless connector of item 25, wherein the first guiding section comprises a hollow waveguide next to the ball portion.

Item 30 is the wireless connector of item 25, wherein the first guiding section is a solid waveguide.

Item 31 is a wireless connector comprising:

a first communication device configured to emit a modulated signal;

a second communication device configured to receive the emitted modulated signal; and

a waveguide centered on an axis and disposed between the first and second communication devices and configured to wirelessly receive the emitted modulated signal from a first end of the waveguide, guide the received signal from the first end to an opposite second end of the waveguide, and wirelessly transmit the guided signal from the second end to the second communication device, the waveguide comprising a plurality of guiding sections, each guiding section in the plurality of guiding sections being centered on the axis, at least one guiding section in the plurality of guiding section being rigid, at least one guiding section in the plurality of guiding sections being more flexible than another guiding section.

Item 32 is the wireless connector of item 31, wherein at least one guiding section in the plurality of guiding sections is configured to slide within or over an adjacent guiding section in the plurality of guiding sections inwardly to reduce a length of the waveguide and outwardly to increase the length of the waveguide.

Item 33 is a wireless communication system comprising:

a plurality of first communication devices disposed on a common first substrate, each first communication device being configured to emit a modulated signal;

a plurality of second communication devices disposed on a common second substrate, each second communication device being associated with a different first communication device and configured to receive the modulated signal emitted by the first communication device; and

a plurality of waveguides, each waveguide being centered on an axis and disposed between a different first communication device and the second communication device associated with the first communication device and configured to wirelessly receive the modulated signal emitted by the first communication device from a first end of the waveguide, guide the received signal from the first end to an opposite second end of the waveguide, and wirelessly transmit the guided signal from the second end to the second communication device, at least one waveguide in the plurality of waveguides comprising a plurality of guiding sections, each guiding section being centered on the axis of the waveguide and configured to slide within or over an adjacent guiding section inwardly to reduce a length of the waveguide and outwardly to increase the length of the waveguide.

Item 34 is the wireless communication system of item 33, wherein at least two waveguides in the plurality of waveguides are attached to each other along the length of the at least two waveguides.

Item 35 is the wireless communication system of item 33, wherein at least one waveguide in the plurality of waveguides comprises a first slot at the first end of waveguide, a portion of the first substrate being inserted into the first slot.

Item 36 is a wireless communication system comprising:

a plurality of first communication devices disposed on a common first substrate, each first communication device being configured to emit a modulated signal; and

a plurality of waveguides, each waveguide being associated with a different first communication device and configured to wirelessly receive the modulated signal emitted by the associated first communication device from a first end of the waveguide, guide the received signal from the first end to an opposite second end of the waveguide, and wirelessly transmit the guided signal from the second end of the waveguide, at least one waveguide in the plurality of waveguides comprising a first slot at the first end of the waveguide, a portion of the first substrate being inserted into the first slot; wherein the waveguides each define a cavity along a length of the waveguide.

Item 37 is the wireless communication system of item 36, wherein each waveguide in the plurality of waveguides comprises a first slot at the first end of the waveguide, a portion of the first substrate being inserted into each first slot.

Item 38 is the wireless communication system of item 36, wherein the telescopic waveguide is tubular.

Item 39 is the wireless communication system of item 36, wherein the cavity of the telescopic waveguide is configured to guide the received signal from the first end to an opposite second end of the waveguide.

Item 40 is the wireless communication system of item 36 further comprising a plurality of second communication devices disposed on a common second substrate, each second communication device being associated with a different first communication device and configured to receive the modulated signal emitted by the first communication device, each waveguide in the plurality of waveguides being disposed between associated first and second communication devices and configured to wirelessly receive the modulated signal emitted by the first communication device from a first end of the waveguide, guide the received signal from the first end to an opposite second end of the waveguide, and wirelessly transmit the guided signal from the second end to the second communication device.

Item 41 is the wireless communication system of item 36, wherein at least one waveguide in the plurality of waveguides comprises a plurality of guiding sections, each guiding section being configured to slide within or over an adjacent guiding section inwardly to reduce a length of the waveguide and outwardly to increase the length of the waveguide.

Item 42 is a wireless communication system comprising:

a plurality of first communication devices disposed on a common first substrate, each first communication device being configured to emit a modulated signal;

a plurality of second communication devices disposed on a common second substrate, each second communication device being associated with a different first communication device and configured to receive the modulated signal emitted by the first communication device; and

a waveguide centered on an axis and disposed between the plurality of first communication devices and the plurality of second communication devices, the waveguide being configured to wirelessly receive the modulated signal emitted by each first communication device from a first end of the waveguide, guide the received signal from the first end to an opposite second end of the waveguide, and wirelessly transmit the guided signal from the second end to the second communication device associated with the first communication device, the waveguide comprising a plurality of guiding sections, each guiding section being centered on the axis and configured to slide within or over an adjacent guiding section inwardly to reduce a length of the waveguide and outwardly to increase the length of the waveguide.

Item 43 is the wireless communication system of item 42, wherein the waveguide is configured to wirelessly transmit the modulated signal emitted by a first communication device to a second communication device not associated with the first communication device.

Item 44 is the wireless communication system of item 42 or 43, wherein the modulated signal emitted by each first communication device comprises a carrier signal modulated with a digital signal, each second communication device being configured to receive the modulated signal emitted by the first communication device associated with the second communication device and to demodulate the received modulated signal to extract the digital signal.

Item 45 is the wireless connector of item 1-35, 40-44, 46, 48-66, wherein at least one of the first and second end guiding sections has a dielectric constant that varies along the length of the end guiding section.

Item 46 is the wireless connector of item 45, wherein at least one of the first and second end guiding sections has a dielectric constant that decreases along the length of the end guiding section in a direction towards the communication device facing the end guiding section.

Item 47 is a wireless connector comprising:

a first communication device configured to emit a modulated signal;

a second communication device configured to receive the emitted modulated signal; and

a waveguide disposed between the first and second communication devices and configured to wirelessly receive the emitted modulated signal from a first end of the telescopic waveguide, guide the received signal from the first end to an opposite second end of the waveguide, and wirelessly transmit the guided signal from the second end to the second communication device, the waveguide having a non-uniform permittivity along at least a portion of a length of the waveguide.

Item 48 is the wireless connector of item 1-47, 49-66 wherein the second communication device is disposed between the first and second ends of the waveguide adjacent to a side of the waveguide, the waveguide being configured to wirelessly transmit the modulated signal from the side of the waveguide to the second communication device.

Item 49 is the wireless connector of item 1-48, 50-66, wherein each of the first and second communication devices comprises a transceiver.

Item 50 is the wireless connector of item 49, wherein the transceiver in each of the first and second communication devices is capable of emitting a power of no more than 1 watt.

Item 51 is the wireless connector of item 1-49, 58-66, wherein the first communication device is capable of emitting a power of no more than 1 watt.

Item 52 is the wireless connector of item 1-49, 58-66, wherein the first communication device is capable of emitting a power of no more than 0.5 watts.

Item 53 is the wireless connector of item 1-49, 58-66, wherein the first communication device is capable of emitting a power of no more than 100 milliwatts.

Item 54 is the wireless connector of item 1-49, 58-66, wherein the first communication device is capable of emitting a power of no more than 50 milliwatts.

Item 55 is the wireless connector of item 1-49, 58-66, wherein the first communication device is capable of emitting a power of no more than 30 milliwatts.

Item 56 is the wireless connector of item 1-49, 58-66, wherein the first communication device is capable of emitting a power of no more than 20 milliwatts.

Item 57 is the wireless connector of item 1-49, 58-66, wherein the first communication device is capable of emitting a power of no more than 10 milliwatts.

Item 58 is the wireless connector of item 1-57, 59-66 further comprising a first dielectric medium disposed between the first communication device and the telescopic waveguide, the dielectric medium being configured to transmit the modulated signal emitted by the first communication device to the first end of the telescopic waveguide, the first dielectric medium having a dielectric constant greater than one.

Item 59 is the wireless connector of item 1-58, 61-66, wherein the telescopic waveguide has a curvilinear lateral cross-section.

Item 60 is the wireless connector of item 59, wherein the lateral cross-section of the telescopic waveguide is a circle, a semicircle, an annulus, a parabolic segment, or an ellipse.

Item 61 is the wireless connector of item 1-60, 62-66, wherein the telescopic waveguide has a rectilinear lateral cross-section.

Item 62 is the wireless connector of item 61, wherein the lateral cross-section of the telescopic waveguide is a polygon.

Item 63 is the wireless connector of item 62, wherein the lateral cross-section of the telescopic waveguide is a regular polygon.

Item 64 is the wireless connector of item 1-63, wherein the waveguide comprises a core of a first dielectric material and the waveguide becomes increasingly narrow in at least one dimension approaching at least one end of the telescopic waveguide.

Item 65 is the wireless connector of item 64, wherein the waveguide comprises an interface end portion located at a first end of the waveguide, wherein the interface end portion comprises bubbles of air or a material of lower permittivity than the first dielectric material.

Item 66 is the wireless connector of item 65, wherein the air or material of lower permittivity increases in volume percentage moving along the length of the interface end portion moving toward the first end of the waveguide.

The embodiments discussed in this disclosure have been illustrated and described herein for purposes of description of preferred embodiments, it will be appreciated by those of ordinary skill in the art that a wide variety of alternate and/or equivalent implementations intended to achieve the same purposes may be substituted for the specific embodiments shown and described herein without departing from the scope of the present invention. Those with skill in the mechanical, electro-mechanical, and electrical arts will readily appreciate that the disclosed embodiments may be implemented with wide variations. This disclosure is intended to cover any adaptations or variations of the embodiments discussed herein.

1. A wireless connector comprising:
a first communication device configured to emit a modulated signal;
a second communication device configured to receive the emitted modulated signal; and
a telescopic waveguide disposed between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device, the telescopic waveguide being centered on an axis and comprising a plurality of guiding sections, each guiding section being centered on the axis and configured to slide within or over an adjacent guiding section inwardly to reduce a length of the telescopic waveguide and outwardly to increase the length of the telescopic waveguide.

2. A wireless connector comprising:
a first communication device configured to emit a modulated signal;
a second communication device configured to receive the emitted modulated signal; and
a telescopic waveguide disposed between the first and second communication devices and configured to wirelessly receive the emitted modulated signal from a first end of the telescopic waveguide, guide the received signal from the first end to an opposite second end of the telescopic waveguide, and wirelessly transmit the guided signal from the second end to the second communication device, the telescopic waveguide comprising a plurality of guiding sections, each guiding section being configured to slide within or over an adjacent guiding section inwardly to reduce a length of the telescopic waveguide and outwardly to increase the length of the telescopic waveguide, wherein at least one guiding section defines a cavity along a length of the guiding section.

3-10. (canceled)

11. The wireless connector of claim 1, wherein the waveguide is tubular and each guiding section is tubular.

12. The wireless connector of claim 11, wherein the cavity of the waveguide is configured to guide the received signal from the first end to an opposite second end of the waveguide.

13. The wireless connector of claim 1, wherein the first and second communication devices are disposed in a housing, wherein the housing has a dimension configured to change.

14. The wireless connector of claim 1, wherein the first communication device is disposed within and stationary relative to a housing and the second communication device is configured to slide into or out of the housing.

15. The wireless connector of claim 1, wherein the first and second communication devices are coupled through at least one wired connection.

16. The wireless connector of claim 1, wherein the first communication device includes at least one first antenna configured to emit the modulated signal and the second communication device includes at least one second antenna configured to receive the emitted modulated signal.

17. The wireless connector of claim 1, wherein at least one guiding section in the plurality of guiding sections of the waveguide comprises a solid dielectric core surrounded by an electrically conductive cladding.

18. The wireless connector of claim 1, wherein the waveguide becomes increasingly wide in at least one dimension approaching at least one end of the telescopic waveguide.

19. The wireless connector of claim 1, wherein the plurality of guiding sections of the waveguide comprises a first guiding section and an adjacent second guiding section being configured to slide inwardly and outwardly within the first guiding section, the second guiding section having a first end disposed within the first guiding section, the second guiding section becoming increasingly wide in at least one dimension approaching the first end of the second guiding section.

20. A wireless connector comprising:
a first communication device configured to emit a modulated signal;
a second communication device configured to receive the emitted modulated signal; and
a waveguide centered on an axis and disposed between the first and second communication devices and configured to wirelessly receive the emitted modulated signal from a first end of the waveguide, guide the received signal from the first end to an opposite second end of the waveguide, and wirelessly transmit the guided signal from the second end to the second communication device, the waveguide comprising a first guiding section and a second guiding section, each of the first and second guiding sections being centered on the axis, a first end of the first guiding section comprising a ball portion, a second end of the second guiding section comprising a socket portion, the ball portion of the first guiding section being disposed within the socket portion of the second guiding portion and free to move within the socket portion in a plurality of directions.

21. The wireless connector of claim 20, wherein the second guiding section is disposed between the first guiding section and a third guiding section, the second guiding sections being configured to slide within or over the third guiding section inwardly to reduce a length of the waveguide and outwardly to increase the length of the waveguide.

22. A wireless connector comprising:
a first communication device configured to emit a modulated signal;
a second communication device configured to receive the emitted modulated signal; and
a waveguide centered on an axis and disposed between the first and second communication devices and configured to wirelessly receive the emitted modulated signal from a first end of the waveguide, guide the received signal from the first end to an opposite second end of the waveguide, and wirelessly transmit the guided signal from the second end to the second communication device, the waveguide comprising a plurality of guiding sections, each guiding section in the plurality of guiding sections being centered on the axis, at least one guiding section in the plurality of guiding section being rigid, at least one guiding section in the plurality of guiding sections being more flexible than another guiding section.

23. The wireless connector of claim 22, wherein at least one guiding section in the plurality of guiding sections is configured to slide within or over an adjacent guiding section in the plurality of guiding sections inwardly to reduce a length of the waveguide and outwardly to increase the length of the waveguide.

24. A wireless communication system comprising:
a plurality of first communication devices disposed on a common first substrate, each first communication device being configured to emit a modulated signal; and
a plurality of waveguides, each waveguide being associated with a different first communication device and configured to wirelessly receive the modulated signal emitted by the associated first communication device from a first end of the waveguide, guide the received signal from the first end to an opposite second end of the waveguide, and wirelessly transmit the guided signal from the second end of the waveguide, at least one waveguide in the plurality of waveguides comprising a first slot at the first end of the waveguide, a portion of the first substrate being inserted into the first slot; wherein the waveguides each define a cavity along a length of the waveguide.

25. The wireless communication system of claim 24, wherein each waveguide in the plurality of waveguides comprises a first slot at the first end of the waveguide, a portion of the first substrate being inserted into each first slot.

26. The wireless communication system of claim 24 further comprising a plurality of second communication devices disposed on a common second substrate, each second communication device being associated with a different first communication device and configured to receive the modulated signal emitted by the first communication device, each waveguide in the plurality of waveguides being disposed between associated first and second communication devices and configured to wirelessly receive the modulated signal emitted by the first communication device from a first end of the waveguide, guide the received signal from the first end to an opposite second end of the waveguide, and wirelessly transmit the guided signal from the second end to the second communication device.

27. A wireless connector comprising:
a first communication device configured to emit a modulated signal;
a second communication device configured to receive the emitted modulated signal; and
a waveguide disposed between the first and second communication devices and configured to wirelessly receive the emitted modulated signal from a first end of the telescopic waveguide, guide the received signal from the first end to an opposite second end of the waveguide, and wirelessly transmit the guided signal from the second end to the second communication device, the waveguide having a non-uniform permittivity along at least a portion of a length of the waveguide.

28. The wireless connector of claim 27, wherein the second communication device is disposed between the first and second ends of the waveguide adjacent to a side of the waveguide, the waveguide being configured to wirelessly transmit the modulated signal from the side of the waveguide to the second communication device.

29. The wireless connector of claim 27, wherein each of the first and second communication devices comprises a transceiver.

30. The wireless connector of claim 27, wherein the waveguide comprises a core of a first dielectric material and the waveguide becomes increasingly narrow in at least one dimension approaching at least one end of the telescopic waveguide.
